(19) United States
(12) Patent Application Publication
(10) Pub. No.: US 2022/0266539 A1
(43) Pub. Date: Aug. 25, 2022

(54) HEATING APPARATUS CAPABLE OF HEATING A HEAT-SHRINKABLE TUBE DIFFERENTIALLY

(71) Applicant: SEWON ELECTRONICS CO., LTD., Pyeongtaek-Si, Gyeonggi-do (KR)

(72) Inventor: Jiming SONG, Weihai City, Shandong Province (CN)

(21) Appl. No.: 17/635,519

(22) PCT Filed: Aug. 12, 2021
(86) PCT No.: PCT/KR2021/010700

§ 371 Date: Feb. 15, 2022

(30) Foreign Application Priority Data
Aug. 13, 2020 (KR) 10-2020-0101526

(51) Int. Cl. B29C 65/68; B29C 65/10

(52) U.S. Cl. CPC B29C 65/68; B29C 65/10; B29L 2031/3462

(57) ABSTRACT

A heat-shrinkable tube heating apparatus of the present invention comprises a pair of heat source boxes that are configured to be plane-symmetrical to each other. A blower pipe and a pair of heating tubes are disposed parallel to each other inside each of the pair of heat source boxes wherein air jet holes are formed side by side on the blower pipe. The pair of heating tubes, each including a heating wire emitting infrared rays, are arranged across an open area on one side of each heat source box, the blower pipe is disposed between the pair of heating tubes to be positioned more inside than the pair of heating tubes from the open area, and the blower pipe is installed so that a pressurized air flowing thereinto is blown out through the air jet holes toward one of both sides of heat-shrinkable tubes placed for being heated.

### FIELD

The present invention relates to a heating apparatus for sealing a wire-connected part by applying heat to a heat-shrinkable tube to ensure that an electrical contact made by wires connected to each other either directly or through terminals can be stably maintained in spite of external vibration or shock.

### DESCRIPTION OF THE RELATED ART

These days, many kinds of devices and appliances are used in daily life, work, leisure activities or medical practices etc. of people. Most of them perform the intended operations or functions based on electrical signal exchanges among their components. Particularly, a large-sized equipment, for example, a vehicle, a communication device, a medical device or the like connects many kinds of cables to each other among a large number of components to enable electrical communication therebetween.

In order to easily connect many kinds of cables to connectors provided on a PCB or the like on which the components are mounted, a metallic terminal is pressed and fixed into a housing after electrically connecting a wire core (an insulator-stripped conductor) of wires constituting a cable to the metallic terminal. Alternatively, if necessary, as illustrated in FIG. 1, wire cores 1a and 1b of both wires are pressed together in a state of being inserted into a coupling terminal 2 to electrically connect both wires.

When connecting both electric wires as illustrated in FIG. 1, a Heat-Shrinkable Tube (HST) 10 is used as a means for stably maintaining the electrically-contacted state together with the coupling terminal 2. When heat is applied to the HST 10 in a state in which the wire-connected part of wires is inserted, the tube 10′ shrinks as illustrated in FIG. 2. During this shrinkage, the thermoplastic resin applied onto the inner circumferential surface of the tube is melted and wraps around the coupling terminal, and it flows out to the outside of the tube.

When the tube is cooled in such a state, the wire-connected part of the wires is completely sealed by the contracted tube 10′ and the solidified resin 10a. Therefore, the electrical contact is not affected by vibration or physical shock, and the inflow of fluid from the outside is blocked, thereby maintaining a stable electrically-contacted state of both wires.

When the wire-connected part of the wires is sealed using a heat-shrinkable tube in this way, the state in which the solidified resin 10a protrudes out of the tube by a predetermined interval 10b, for example, by about 1 mm is regarded as the acceptance criterion of connection quality in general. The reason is that, if the resin does not protrude, the resin layer around the inner surface of an HST may not be sufficiently melted, and if it protrudes more than that, there may be a void inside HST due to excessive leakage of the resin solution.

In the operation of sealing the wire-connected part of the wires by heating the HST, as illustrated in FIG. 2, the Heat-shrinkable tube Heating Apparatus (HHA) 100 configured and operated as illustrated in FIGS. 3 and 4 is used.

The HHA 100 is largely composed of a frame 110, a mounting table 120 and a heating unit 130. In FIG. 3, the heating unit 130 is partially cut out so that the internal configuration can be seen.

The frame 110 is provided with four pairs of supports 111 for fixing the mounting table 120 thereon. A pair of shafts 112 that allow the heating unit 130 to reciprocate back and forth in a slide manner are also installed on the frame 110 in parallel to the bottom plane 113.

The mounting table 120 is equipped with a pair of cradle bars 121 arranged parallel to each other in the moving direction of the heating unit 130. A plurality of fixtures 122a and 122b are arranged side by side in two rows and are coupled onto the pair of cradle bars 121. The fixtures adjacent to each other are spaced apart by an interval in which the electric wire 140, the wire-connected part of which is inserted into the HST 141, can be fixedly sandwiched.

The heating unit 130 includes a pair of Heat-Source Boxes (HSBs) 131 and 132 configured to be plane-symmetrical to each other on the inner and outer planes thereof. The HSBs 131 and 132 are coupled to each other while being spaced apart from each other by a predetermined distance vertically. A pair of slide rods 133 that can reciprocate along the shaft 112 are coupled to the bottom of the lower HSB 132.

Because the slide rods 133 move forward and backward along the shaft 112 by driving of a motor or the like, the HSBs 131 and 132 coupled to the rods 133 also reciprocate between a position shown in FIG. 3 and another position shown in FIG. 4.

The pair of HSBs 131 and 132 of the heating unit 130 slidably coupled to the pair of shafts 112 fixed to the frame 110 have the same distance from each other to the wires 140 to be temporarily fixed between the fixtures on the mounting table 120.

Accordingly, the HST heating by the upper HSB 131 and the lower HSB 132 acts equally from above and below.

In one HSB, three heating tubes 13ᵢ (i=1, 2, 3) are built in a box-shaped housing having a double wall with a space therebetween. Each heating tube 13ᵢ is a U-shaped metal tube and is equipped with a spirally-twisted hot plate 13a inserted therein along the tube. The space 14 between the double wall is filled with an insulating material. The hot plate 13a converts a supplied current, that is, electrical energy into thermal energy, and the temperature at which the hot plate 13a generates heat is specified by adjusting the magnitude of the applied current. The heat of the hot plate 13a heats the air in the inner pocket through the metal tube.

In the pair of HSBs 131 and 132, rectangular Hot-Air Windows (HAWs) 15 are formed on the surfaces opposite to each other so that heated air can be discharged. The HAWs are formed on a region to face a series of HSTs to be placed on the mounting table 121. The size of the HAW may be somewhat smaller than that of the area occupied by the placed HSTs.

A pair of blower pipes 16 are installed in the rear of the built-in heating tubes 13ᵢ, that is, further inside the HSB. Air blowing holes 16a perforated on the blower pipe 16 in a direction perpendicular to a virtual plane parallel to the HAW 15 are formed on the circumferential surface of the blower pipe 16 side by side along the longitudinal direction.

FIG. 5 is a cross-sectional view showing more clearly the positional relationship between the elements in the configuration of the HSB described above.

The blower pipe 16 is inserted through a hole formed the rear plane of the housing of the heating unit 130, and a hose for supplying a pressurized air is connected to the end of the blower pipe 16. Thus, when a pressurized air is supplied through the hose, it is blown out, through a series of air blowing holes 16a, vertically downward (and upward) to the HAW 15 (30). This flow of pressurized air sweeps the air in the inner pocket heated to a high temperature by the heating tubes 13ᵢ to blow out heated air through the HAW 16.

Accordingly, in case that the HHA 100 is in the heating state illustrated in FIG. 4, the HSTs 141 individually wrapping the wires 140 placed side by side on the mounting table 121 positioned between both HSBs 131 and 132 are heated at the same time by the hot air blown out from the upper and lower sides. Then, as described with reference to FIG. 2, each HST is contracted to seal the wire-connected part of each of wires while its resin layer is melted.

As such, the HHA 100 seals the wire-connected parts of the wires with HSTs at a time as much as the number of wires that can be fixed with the fixtures 122a and 122b of the mounting table 121.

However, since the above-described HHA 100 sweeps out the internal air heated by the heating tubes 13ᵢ (i=1, 2, 3), which are heated according to the set temperature, toward the HAW 15 using the flow of pressurized air, the space 31 up to the periphery as well as the front of the HAW 15 rises to almost the same temperature by the hot air.

On the other hand, when both electric wires are to be connected to each other, the their heat-resistance properties may not be the same. FIG. 6 shows an example in which an HST 40 is applied to the connection between both wires having different heat-resistance properties, for example, an electric wire 41 having a heat-resistant outer sheath and another electric wire 42 with only an inner insulator of no heat resistance or weak heat resistance.

If the above-described HHA 100 is used to seal the wire-connected part of both wires illustrated in FIG. 6, the hot air blown out through the HAWs 15 not only applies onto the HST 40 but also partially flows to both sides of each of the electric wires 41 and 42 as it spreads to the surroundings, thereby affecting the covering material wrapping the conductor. Under this condition, the heat-resistant outer sheath can withstand the temperature raised by such hot air, but the inner wrapping material with no or weak heat-resistance may be partially melted. This leads to a failure in the wire connection where a conductor not covered by the HST is exposed.

For this reason, the HHA 100 cannot be used if both wires of which connection part is to be sealed by an HST are different in heat resistance property.

Therefore, when sealing the connection part of wires with different heat resistance, shown in FIG. 6, by using an HST, a small hand-held heating device is used to adjust the heating direction so that the hot air acts only on an HST not to affect the wrapping material with no or weak heat resistance, while checking visually whether the inner resin layer is melting out. However, such manual work has problems in that the productivity is excessively lowered, and the degree of protrusion of the solidified resin is not uniform, so that the defective rate is also increased.

### SUMMARY OF THE INVENTION

It is an object of the present invention to provide a heating apparatus capable of differentially heating an HST for sealing a connection part between electric wires.

It is another object of the present invention is to provide a heating apparatus capable of differentially heating an HST by adjusting the heating environment depending on the length of HSTs of various dimensions.

It is another object of the present invention is to provide a heating apparatus capable of reducing the size of a component for heating an HST.

It is another object of the present invention is to provide a heating apparatus capable of ensuring easy confirmation on an electrical failure of a component for heating an HST.

The scope of the present invention is not necessarily limited to the above explicit statements. Rather, the scope of the present invention covers anything to accomplish effects that could be derived from the specific and illustrative explanations of the present invention below.

An apparatus for heating HSTs in accordance with one aspect of the present invention, comprises: a mounting table on which HSTs for sealing interconnected wires are to be placed in parallel; a frame configured to support and fix the mounting table; and a heating unit, comprising a pair of HSBs, configured to be mounted on a shaft provided in the frame and to reciprocate along the shaft in such a way that the HSTs placed on the mounting table are positioned in the space between the HSBs when moved to the mounting table, wherein the pair of HSBs are plane-symmetrical to each other, and a predetermined area on each side of the pair of HSBs facing each other is open. The apparatus further comprises a blower pipe and a pair of heating tubes disposed parallel to each other inside each of the pair of HSBs wherein Air Jet Holes (AJHs) are formed side by side on the blower pipe. The pair of heating tubes, each including a heating wire emitting infrared rays, are arranged across the open area, the blower pipe is disposed between the pair of heating tubes to be positioned more inside than the pair of heating tubes from the open area, and the blower pipe is installed so that a pressurized air flowing thereinto is blown out through the AJHs toward a point biased to one side with respect to a virtual plane that bisects the open area vertically.

In one embodiment of the present invention, each of the pair of heating tubes is configured to include a housing in which the heating wire is inserted in a longitudinal direction of the housing, and at least one side of the housing facing the open area is made of a transparent material.

In one embodiment of the present invention, the blower pipe is installed so that the pressurized air is blown out through the AJHs toward an arbitrary point within a zone on the HSTs, which are placed on the mounting table, made by vertically extending a surface of either of the pair of heating tubes exposed to the open area upto the HSTs, wherein the arbitrary point may be at a distance of 20% 40% of length of the HST from one end thereof.

In one embodiment of the present invention, each of the HSTs is placed on the mounting table in such a way that its one side into which an electric wire having a relatively strong heat-resistance property is inserted is located on a side toward which the pressurized air is blown through the AJHs.

In one embodiment of the present invention, the pair of heating tubes are arranged such that a distance between them, i.e. a distance between the outer surfaces of them is in a range of 40% to 60% of length of the HST to be placed on the mounting table.

In one embodiment of the present invention, a series of guide through-holes are formed on both one plane and opposite plane, respectively, of each of the HSBs, and a fastener is inserted into one of the series of guide through-holes to fix one of the heating tubes at any position on a disposed inner surface of the HSB. In the present embodiment, fastening holes for the fastener to be inserted and coupled are formed at both ends, respectively, of each of the heating tubes,

In one embodiment of the present invention, a binding ring is fixedly combined onto one side of each of the pair of HSBs, and the blower pipe inserted through the binding ring into the each HSB is rotatable, and the blower pipe is fixed not to rotate by a fixture coupled to the binding ring. In the present embodiment, a mark may be added, on an outer circumferential surface of the blower pipe exposed to outside without being inserted into the pair of HSBs, to indicate a direction in which the pressurized air is blown out through the AJHs, or that is 180 degrees out of phase with the direction.

In one embodiment of the present invention, the AJHs are formed on the blower pipe at same interval as an interval between the HSTs placed on the mounting table, and correspond one-to-one to the HSTs placed on the mounting table.

In one embodiment of the present invention, the apparatus further comprises a second blower pipe for cooling HSTs installed in the frame under the mounting table. A plurality of pairs of air blowing holes, each pair being located at both points on a circumference that form a predetermined central angle, are repeatedly formed along a longitudinal direction of the second blower pipe, wherein the predetermined central angle is an angle such that the pressurized air blown out through each pair of the air blowing holes is directed to both sections, respectively, on the HST placed on the mounting table and each of the both sections is what is made on the HST when one plane of each of the pair of heating tubes is extended in the vertical direction upto the HST.

In accordance with the present invention described above or at least one embodiment of the present invention to be described in detail below with reference to appended drawings, an HHA can heat both sides of an HST differentially, more specifically, can heat both sides of an HST under heating conditions that are not same with each other. Accordingly, the heating apparatus of the present invention can be applied to heating an HST to seal a connection part between both electric wires having different heat resistance. That is, the heating apparatus can heat an HST without thermal damage to the covering material of the electric wire, which has no or weak heat resistance, adjacent to the HST to melt the resin layer applied to the inner circumferential surface of the HST, thereby completely sealing the connection part of the wires by the contracted HST.

As a result, the works of sealing the connection part of wires having different heat resistance properties using an HST can be quickly performed in large quantities by the heating apparatus of the present invention, so that productivity would be greatly improved.

In one embodiment according to the present invention, since it is possible to adjust the interval between the heating sources for heating both sides of an HST, respectively, and with this, the direction of a pressurized air to be blown toward either of the both sides can also be adjusted, the zone to be intensively heated can be set according to the length of an HST even if the length of an HST for sealing the connection part of the wires with different heat resistance is changed. Therefore, the heating apparatus according to the present invention can be applied to HSTs of various lengths.

In the heating apparatus of the present invention, the heating sources for heating HSTs are equipped with heating wires emitting infrared rays and are housed in a transparent material through which the infrared rays can be radiated. Therefore, when electrical energy is supplied to the heating wires, it is possible to visually perceive that the heating wires shine in red. In contrast, since the conventional heating tube is configured such that a spiral hot plate that generates heat is built into the metal tube, as described above, it is difficult to immediately determine which heat source is the problem even if sealing defects occur in some of a series of HSTs due to a heating failure caused from such as a disconnection in the circuit for supplying electrical energy to the heat sources of the heating apparatus.

However, in case of the heating sources of the present invention, since it can be immediately known that a heat wire which does not glow red is faulty, it is possible to quickly identify and repair the cause of the malfunction of the heating source. This means that the maintenance of the heating apparatus is significantly improved compared to the prior art.

### BRIEF DESCRIPTION OF THE DRAWINGS

FIGS. 1 and 2 illustrate a general method of sealing wires and a wire-connected part thereof using an HST;

FIGS. 3 and 4 are diagrams showing the configuration of a conventional HHA and how it works;

FIG. 5 is an example of a cross-sectional view showing the heating method in more detail with respect to only one side for the case where the conventional HHA heats HSTs from above and below at the same time;

FIG. 6 is a diagram schematically showing the flow of heated air when the heating method shown in FIG. 5 is applied to an HST for sealing the wire-connected part of wires that differ in heat resistance;

FIG. 7 is a perspective view showing the configuration of an HHA of an embodiment of the present invention, partially cut away with respect to the configuration for heating HSTs, where configurations at both states made by reciprocating motion are shown in the same drawing;

FIG. 8 is an example of a cross-sectional view showing the heating method in more detail with respect to only one side for the case where the HHA of FIG. 7 heats HSTs for sealing the wire-connected part of wires having different heat resistance properties from above and below simultaneously;

FIGS. 9 and 10 are diagrams showing the configuration and method of air cooling in the HHA of FIG. 7 embodied according to the present invention in order to quickly complete sealing with HSTs that have been shrunk by cooling heated HSTs and solidifying the molten resin solution immediately;

FIG. 11 is a view showing the configuration for adjusting the interval between a pair of heating tubes for heating HSTs in an infrared manner, in accordance with another embodiment of the present invention, where the adjustment-related portion is partially cut out; and

FIG. 12 illustrates the configuration additionally provided in the HHA, according to the present invention, in order to adjust and fix a direction of blowing out pressurized air to be biased to either of both sides of a placed HST.

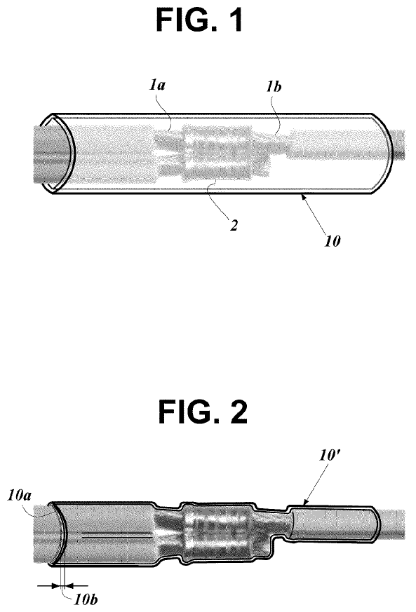

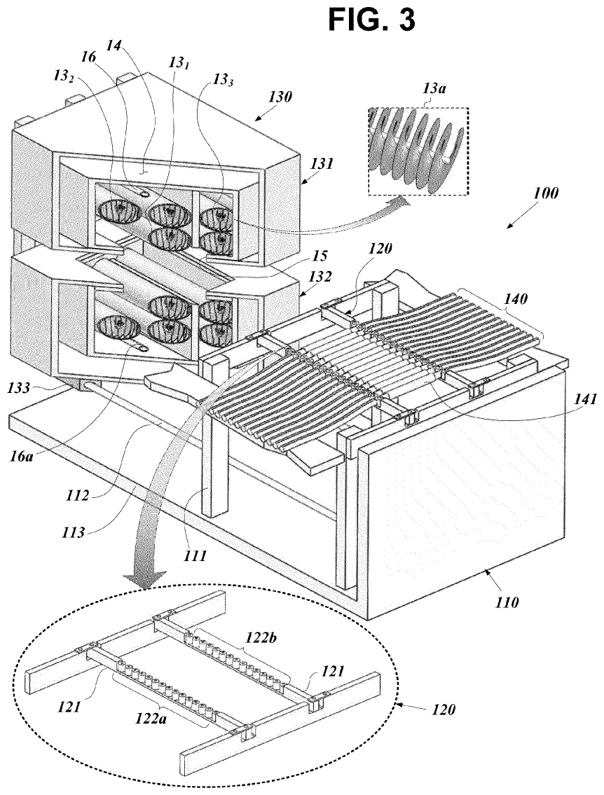

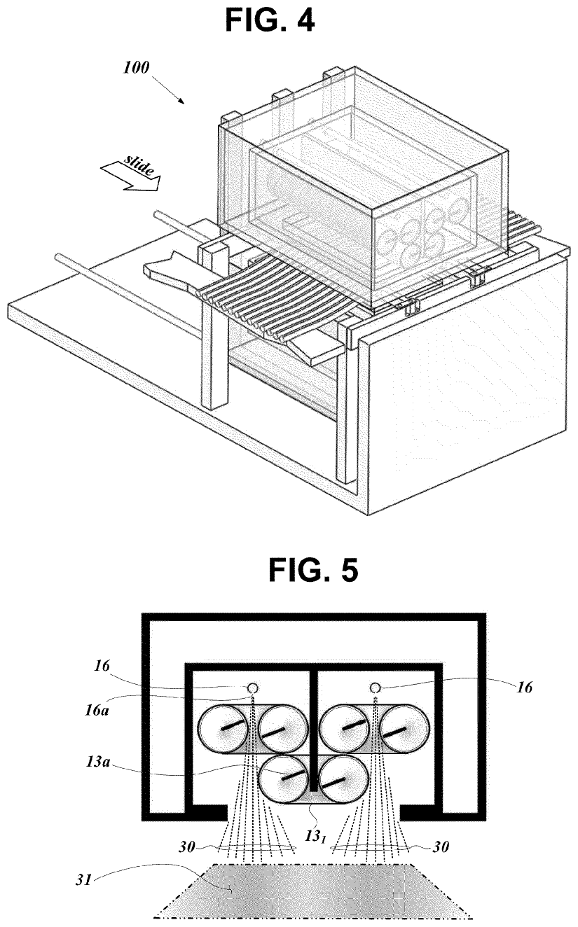

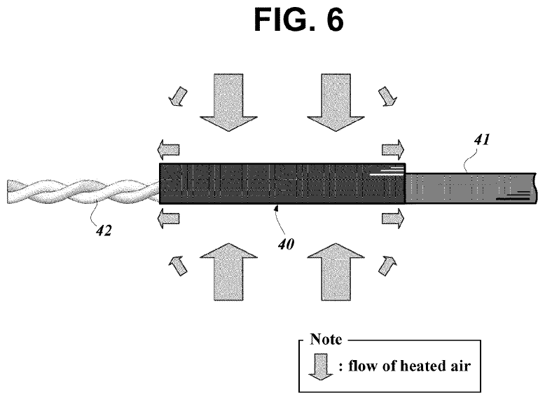

### DETAILED DESCRIPTION

In what follows, embodiments of the present invention will be described in detail with reference to appended drawings.

In the following description of the embodiments of the present invention and the accompanying drawings, the same reference numerals or symbols designate the same elements unless otherwise specified. Of course, for convenience of explanation and for the sake of understanding, the same components may be indicated by different reference numbers or symbols if necessary.

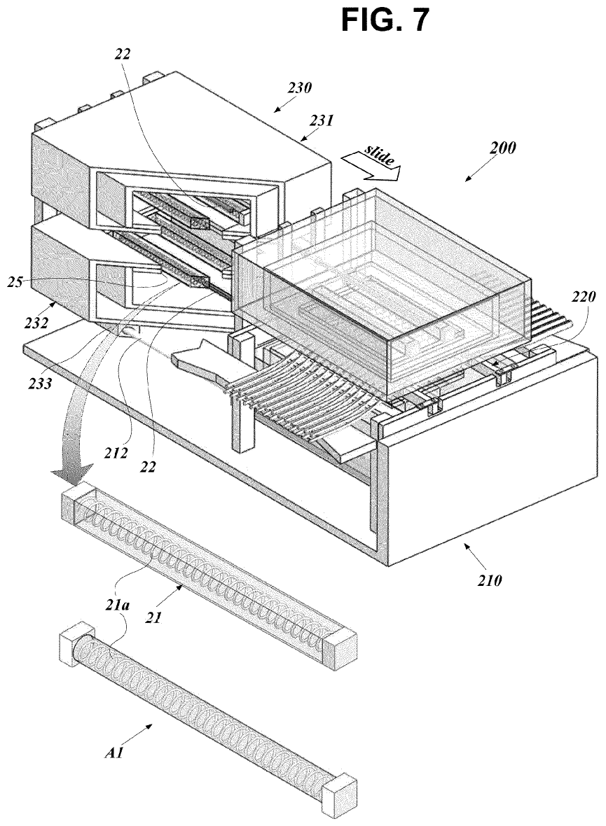

FIG. 7 illustrates an HHA 200, configured according to one embodiments of the present invention, that can heat an HST differentially with respect to both sides thereof.

The HHA 200 configured according to one embodiments of the present invention of is largely composed of a frame 210, a mounting table 220, and a heating unit 230. FIG. 7 is a perspective view showing the configuration of the HHA where the heating units 230 are partially cut away to reveal the inside, and the heating unit in the moved state, which heats a plurality of HSTs placed on the mounting table 220 for sealing of the wire-connected part, is superimposed together.

The heating unit 230 consists of a pair of HSBs 231 and 232 spaced apart from each other at a predetermined interval, and the HSBs are structured in plane symmetry with each other. A pair of slide rods 233 bound to the bottom plane of the lower HSB 232 are slidably coupled to a pair of shafts 212, which is installed on the frame 210, to reciprocate along the shafts 212.

The pair of HSBs 231 and 232 of the heating unit 230 slidably coupled to the pair of shafts 212 fixed to the frame 210 have the same distance from each other to the wires 140 to be temporarily fixed side by side in parallel between the fixtures on the mounting table 220. Accordingly, HST heating by the upper HSB 231 and the lower HSB 232 acts equally from above and below.

In one HSB, two heating tubes 21 are built in a box-shaped housing having double wall with a space therebetween. Each heating tube 21 is configured in a form in which a spiral heating wire 21a is inserted in a long square-typed case made of a transparent material such as glass. As another example, the case housing the heating wire 21a may be circle-typed as shown together in the figure (A1). The shape of the case may be arbitrary as long as it satisfies the property of passing through infrared rays. The space between the double wall is filled with an insulating material. The spiral heating wire 21a provided in the transparent case has a characteristic of emitting infrared rays when an electric current, that is, electrical energy is supplied.

Because the heating wire 21a emits infrared rays, it glows in red. Failure as a heat source due to a problem in the electrical energy supply circuit or disconnection of the heating wire can be easily found out based on whether or not the heating wire is glowing in red.

In one embodiment according to the present invention, the housing in which the pair of heating tubes 21 are installed may not have double wall structure in which the space therebetween is filled with insulation. That is, in the present embodiment, each of the HSBs 231 and 232 may be configured as a single-walled housing. To this end, an infrared reflective material may be applied to the surfaces of inner pocket of each housing, or a mirror coated with an infrared reflective material may be attached to the inner surfaces. In this way, it is possible to prevent the single-walled housing from being heated by infrared rays radiated in all directions for heating the placed HSTs.

In order to allow the infrared rays radiated from the heating wire 21a to pass through, the Infrared-ray Radiation Windows (IRW) 25 opened in a rectangular shape are formed on mutually-facing planes of both HSBs 231 and 232. The IRWs 25 are formed on a region facing a series of HSTs to be placed on the mounting table 220. Compared with the virtual area covered by the placed HSTs, the width (dimension in a direction perpendicular to the sliding direction of the heating unit) of IRW is not wider, and its length (a dimension in a direction parallel to the sliding direction of the heating unit) is longer. The pair of heating tubes 21 are arranged and fixed in parallel with each other across the IRW 25.

Preferably, the heating tube 21 is configured to have a length being capable of exposing its heating wire 21 entirely within the section corresponding to the IRW 25. The pair of heating tubes 21 are arranged such that a distance 64 between them is in the range of 40-60% of the length of an HST to be heated. Of course, this exemplary range may vary depending on the characteristics of the HST.

In one embodiment according to the present invention, an infrared reflective film may be provided on surfaces of the heating tube 21 except for the surface facing the IRW 25 by coating an infrared reflective material thereon. In this way, almost all of the thermal energy converted from the electrical energy is directed toward the IRW 25, thereby increasing the energy efficiency in heating HSTs. That is, it is possible to configure a desired heating condition by supplying less electrical energy.

In each of the HSBs 231 and 232, a single blower pipe 22 is provided further inside from the center of the built-in pair of heating tubes 21. One end of this blower pipe 22 is blocked. Air Jet Holes (AJHs) are formed side by side along the longitudinal direction on the circumferential surface of the blower pipe 22. The blower pipes 22 are installed and fixed to both HSBs 231 and 232 respectively so that the AJHs face a point that is biased to one side on the basis of an imaginary center line that bisects the IRW 25.

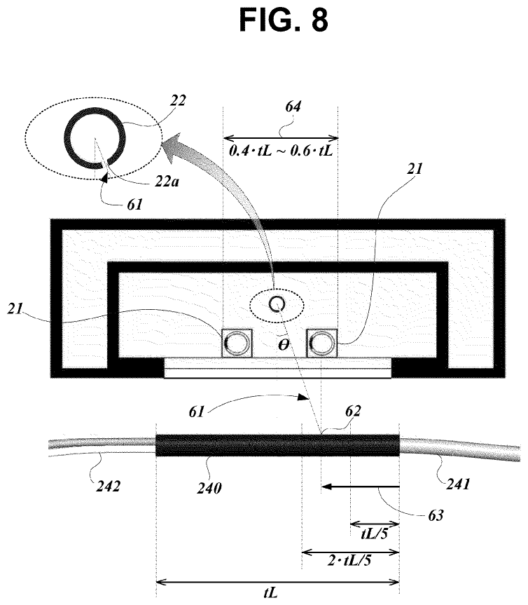

FIG. 8 is a cross-sectional view showing more clearly the positional relationship between the elements in the configuration of the HSB 231 or 232 described above.

As illustrated in FIG. 8, The blower pipe 22 is installed and fixed so that the direction 61 of the series of AJHs 22a, which are formed side by side along the longitudinal direction on the circumferential surface, is deviated by a predetermined angle θ from the vertical direction, so that the extension of the axis of each AJH points toward a spot 62 where the virtual plane extending from the center line of either heating tube to the HST 240 in the vertical direction meets the HST 240 to be placed on the mounting table 220.

In a preferred embodiment according to the present invention, the spot 62 at which the AJHs 22a are directed on the HSTs 240 is an arbitrary point within a section corresponding to range of about 20-40% of the total length (tL) of the HST from its one end where the wire 241 wrapped with a heat-resistant sheath is inserted.

The frame 210 and the mounting table 220, which are components of the HHA 200 other than the heating unit 230 of which configuration has been described in detail above, may have the same configuration as the conventional HHA 100. Accordingly, detailed descriptions of these components will be omitted.

Since each of the HSBs 231 and 232 of the HHA 200 is equipped with the infrared heating tubes 21 having a very narrow cross-sectional area compared to the cross-sectional area of the U-shaped heating tube 13ᵢ of the conventional HHA 100, and even two heating tubes 21 arranged horizontally can apply, as a heat source, sufficient heat energy necessary for the shrinkage of HSTs, the space to be occupied by the heating unit can be greatly reduced compared to the conventional HSBs 131 and 132. Accordingly, the frame 210 may be configured with a dimension that occupies a narrower space, to fit the reduced size of the heating unit, than that of the conventional HHA.

In addition, since the heating tube 21 composed of a heating wire emitting infrared rays occupies a very narrow width compared to the conventional U-shaped heating tube 13ᵢ, there are advantages in that factors affecting each other with respect to the object to be heated are greatly reduced, and the heating area is concentrated, in comparison with the conventional heating method. Conventionally, since the heated air is transferred to the HSTs in a convection manner, it is impossible to separate the heating on both sides of HST from each other. On the contrary, since the pair of heating tubes adopted according to one embodiment of the present invention transmits thermal energy mainly in a radiative manner, separation in heating for both sides of HST is possible to some extent. That s, the zone to be heated intensively by infrared rays can be separated on the HSB to some extent.

When the heating unit 230 is positioned in a relative positional relationship with the HSTs 240 placed on the mounting table 220 for heating, as illustrated in FIG. 8, the infrared rays emitted from the pair of heating tubes 21 are irradiated through the IRWs 25 onto the HSTs 240 from above and below, respectively. At the same time, the pressurized air flowed into the blower pipe 22 is blown out from the AJHs 22a, and is directed toward one side of each HST, that is, toward the side where the wire 241 having a heat-resistant outer shell is inserted, and continuously hits that side.

Heating is started from the vicinity of the HST 240 irradiated with infrared rays, so that the inner resin layer is melted and the tube is contracted. The side of the HST to which the pressurized air is applied is heated to a higher temperature than the other side to which the pressurized air is not applied because the surrounding air particles heated by the heating tube also continuously collide with that side in addition to direct heating by infrared rays. That is, both sides of the HST are differentially heated. The heated temperature spreads around a heated spot depending on the heat conduction of the HST, causing the HST to contract and the area where the inner resin layer melts to expand.

During this time, the other side of HST to which the pressurized air is not applied is also heated by the irradiated infrared rays and is contracted starting from the irradiated spot while the resin layer applied to the inside of HST is melted, and this working is spread to the surroundings.

In the above heating method using the HSBs 231 and 232, although the pressurized air for heating one side of the HST to a higher temperature partially flows toward the electric wire 241 having a heat-resistant sheath and the warmed ambient temperature is transmitted to that wire, the sheath of that wire is not thermally damaged due to its heat resistance.

On the other side of the HST to which pressurized air is not applied according to the differential heating method as above, the portion of the HST heated by infrared rays expands to surroundings by heat conduction as the HST contracts and its inner resin layer melts, so that it takes a long time, compared to the one side to which the pressurized air is applied as well, until the heat is transferred to the electric wire 242 wrapped by only the inner insulator of no or weak heat resistance.

Therefore, if the heating unit 230 is set to return to the original position on the mounting table 220 after heating only until the time when the inner resin of the HST flows out by infrared heating from the side which the wire 242 with no or weak heat resistance is inserted into, the non-heat-resistant electric wire 242 is not thermally damaged at all, and the connection part of both electric wires 241 and 242 is sealed by the HST.

Sealing is completed when the molten resin solution solidifies again. Therefore, in one embodiment according to the present invention, the HHA 200 may comprise a cooling pipe combined to the frame 210 in order to make the molten resin solution solidify faster.

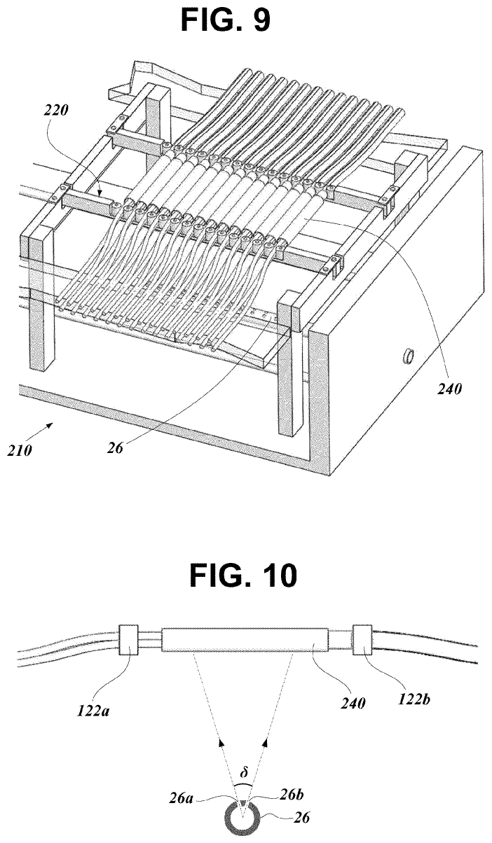

FIGS. 9 and 10 show the mounting table 220 and a series of wires together for the configuration according to the present embodiment in which a cooling pipe 26 is additionally provided to the frame 210. FIG. 9 is a partial perspective view, and FIG. 10 is a view showing the cross-section of the cooling pipe 26 and its positional relationship with the wire-inserted HST placed on the mounting table 220.

As shown in FIGS. 9 and 10, several pairs of Air Blowing Holes (ABHs) 26a and 26b, each pair forming a predetermined central angle θ toward the top where the HSTs 240 are placed, are formed side by side along the longitudinal direction of the cooling pipe 26. Since two directions at which the pair of ABHs 26a and 26b are directed respectively form a predetermined central angle θ, the cooling pipe 26 is installed and fixed to the frame 210 in such a way that both directions (namely, intended directions of pressurized air jet) are set to face locations on both sides of the HSTs 240 placed on the mounting table 220 wherein each of those locations is a point on HST at or near which a virtual plane extending vertically from the center line (or one side) of each heating tubes 21 meets the HST, or a point within a zone on the HST that is made by vertical extension of both side planes of each heating tube.

When the heating unit 210 slides back to the original position after differentially heating, as described above, a series of HSTs placed on the mounting table 220, compressed air is flowed into the cooling pipe 26. Then, the compressed air is blown toward both sides of HSTs through each of the ABHs 26a and 26b, thereby forcibly cooling the heated HSTs.

By such forced cooling, the molten resin liquid is immediately solidified, so that the sealing for the electrically-connected-part of both wires connected to each other is completed quickly.

The number of ABHs formed side by side in two rows in the cooling pipe 26 is preferably twice the number of HSTs that can be maximally fixed to the mounting table 220. That is, the ABHs are formed in the cooling pipe 26 so that each pair of ABHs 26a and 26b correspond to each of the HSTs to be placed on the mounting table.

Likewise, in the case of the blower pipe 22 for differential heating described above provided in each of HSBs 231 and 232, it is preferable that one AJH is formed to correspond to one HST.

In the embodiment in which the blower pipe 22 and the cooling pipe 26 are mounted on the heating unit 230 and the frame 210, respectively, they are fixed so that their air holes are on the same vertical plane exactly one-to-one with each location on the mounting table 220 where an HST for sealing a connected wire is placed.

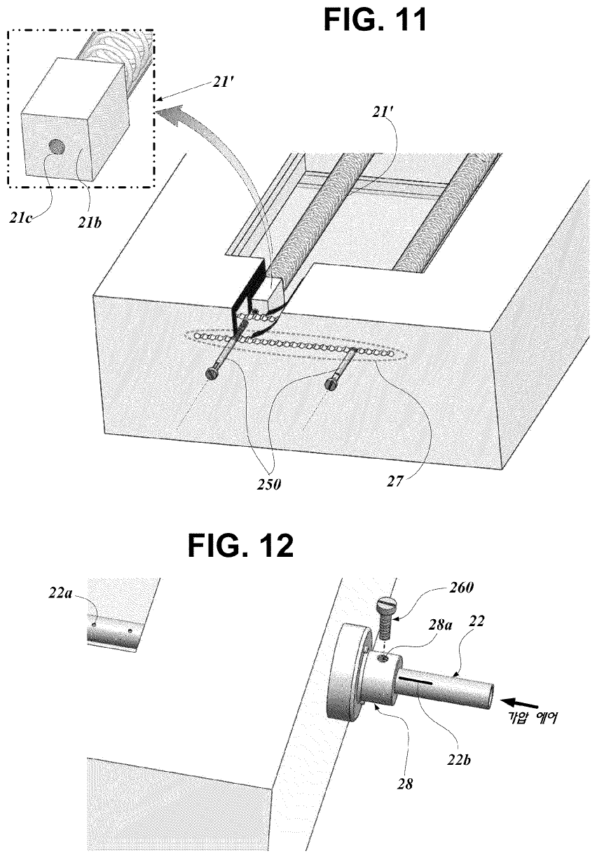

In the embodiments described so far, it is assumed that the position of the pair of heating tubes 21 installed in both HSBs 231 and 232 respectively is fixed. If the length of an HST for sealing the connection part of both wires is changed, it may be necessary to change the zone onto which infrared rays are mainly irradiated in order to increase the efficiency of heating. To this end, in another embodiment according to the present invention, each of the HSBs 231 and 232 has a structure in which the interval between the pair of heating tubes provided therein is adjustable as needed. FIG. 11 illustrates a structure of an HSB in which the interval between heating tubes can be adjusted according to the present embodiment.

In the embodiment shown in FIG. 11, a screw-typed fastening hole 21c is formed to a predetermined depth, along the longitudinal direction of the heating tube, on the center of the terminal block 21b at both ends of each heating tube 21′ equipped with a heating wire in a cylindrical transparent case. A series of guide holes 27 are formed in succession horizontally on the front and rear planes of each HSB. These guide holes 27 are formed so as to penetrate the double wall completely, as shown in FIG. 11 of partially cut-out view, if each HSB is configured with double wall for filling the insulating material therebetween.

The fastening holes 21c and the guide holes 27 are formed to have the same diameter, and the diameter thereof is the same as that of a long rod-shaped fastener 250 having a male-threaded end.

When it is necessary to adjust the position or spacing of the heating tubes 21′ as the type or length of the HST for sealing the connection part of wires is changed, a worker using the HHA 200 first loosens all fasteners 250 fastened to the guide holes from the front and rear planes of the upper and lower HSBs in order be separated from the fastening hole 21c of the heating tube 21′. Then, the heating tubes are moved to the desired positions. At the moved position, the fasteners 250 are again inserted through a proper guide hole into the fastening holes 21c from the front and rear planes respectively and screwed thereon to fix the heating tubes. After these settings are completed, the HHA can be applied to differentially heat both sides of HSTs with new dimensions.

On the other hand, when changing the position/interval of the heating tubes 21′ installed and fixed in each HSB, it may be also necessary to finely adjust the blowing direction of the pressurized air from the blower pipe 22. Therefore, in one embodiment according to the present invention, the blower pipe 22 is installed so as to be rotatable without being completely fixed. FIG. 12 illustrates an installation structure for the blower pipe 22 of which a pressurized air blowing direction can be adjusted as desired according to the present embodiment. FIG. 12 shows a portion of the rear plane, which is the side through which the pressurized air is supplied, of the HSB excluding the heating tubes.

In the present embodiment, as illustrated in the figure, a cylindrical binding ring 28 having a stepped outer circumferential surface is coupled to the side of each HSB to which the blower pipe 22 is connected. The blower pipe 22 extends into the HSB through the center of the binding ring 28. A threaded through-hole 28a penetrating in the vertical direction is formed in the binding ring 28. According to other embodiments, the through-hole 28a may be formed in a horizontal direction or in an arbitrary direction.

The blower pipe 22 is rotatable while being inserted into the HSB through both the binding ring 28 and a through-hole formed on the rear plane of the HSB. When the blowing direction of the pressurized air suitable for the length of the HST to be used for sealing is determined, a worker rotates the blower pipe 22 little by little as needed so that the AJHs 22a formed thereon face the predetermined direction. Then, a fixing screw 260 is inserted into the through-hole 28a and rotated. Finally, as the fixing screw 260 enters the through-hole 28a, it strongly fixes the blower pipe 22 not to be rotated.

In this way, the direction at which the pressurized air is directed from the blower pipe 22 is adjusted to a desired point on one side of the HST.

In a state in which all the components of the HHA 200 are mounted, it is not easy to rotate the blower pipe 22 as much as desired while watching the direction toward which the AJHs 22a of the blower pipe 22 face. The direction of the AJHs 22a can be checked only through the open IRW 25. However, since a pair of HSBs face each other at a narrow interval, it is not easy to see the AJH therebetween.

Therefore, in one embodiment according to the present invention, a specific mark 22b for indicating the direction of the AJHs 22a is added to the outer circumferential surface of the blower pipe 22. The position of the mark is in the vicinity adjacent to the binding ring 28 in the condition that the blower pipe 22 is mounted in a position required for normal operation. This specific mark may be marked in a specific color, or may be a groove engraved on the outer circumferential surface to indicate the blowing direction of the pressurized air.

Because a worker can rotate the blower pipe 22 appropriately to match the desired pressurized air blowing direction while looking at the specific mark 22b on the blower pipe, and then fix it using the fixing screw 260, the adjustment of the air blowing direction becomes very convenient.

The directions of the pressurized air to be blown out for differential heating from the blower pipes, which are installed respectively on the upper and lower HSBs, are at a predetermined angle to each other, and one is upward and the other is downward. Thus, if the specific mark 22b is made only for the blowing direction of the pressurized air, from the work's line of sight, one mark would be located on the outer a circumferential surface of the rear of the blower pipe. Then, in case of adjusting the blower pipes 22 to a desired angle, one blower pipe could be adjusted while standing, but the other might be adjusted while squatting.

In order to avoid the inconvenience in such an adjustment operation, in an embodiment according to the present invention, an additional mark is also added to a point on the circumference of the blower pipe 22 opposite to the air blowing direction, that is, 180 degrees out of phase with the pressurized air blowing direction, in addition to the specific mark 22b added for the pressurized air blowing direction. This additional mark may be painted or engraved distinctively from the specific mark 22b indicating the direction in which the pressurized air is blown out. From the additional mark of this embodiment, a worker intuitively grasps whether the mark seen in the current line of sight is the pressurized air blowing direction or the opposite direction, and can adjust, in the same working posture, the blower pipes 22 of the upper and lower HSBs to any desired angle.

Unless the various embodiments, for the heating apparatus capable of heating an HST differentially, described so far are incompatible with each other, the explained embodiments can be properly chosen in various ways and then combined to embody the concept and idea of the present invention.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

What is claimed is:

1. An apparatus for heating Heat-Shrinkable Tubes (HSTs), comprising:
a mounting table 220 on which HSTs for sealing interconnected wires are to be placed in parallel;
a frame 210 configured to support and fix the mounting table 220;
a heating unit, comprising a pair of Heat Source Boxes (HSBs) 231 and 232, configured to be mounted on a shaft provided in the frame 210 and to reciprocate along the shaft in such a way that the HSTs placed on the mounting table 220 are positioned in the space between the HSBs when moved to the mounting table 220, wherein the pair of HSBs are plane-symmetrical to each other, and a predetermined area 25 on each side of the pair of HSBs facing each other is open; and
a blower pipe 22 and a pair of heating tubes 21 disposed parallel to each other inside each of the pair of HSBs, Air Jet Holes (AJHs) 22a being formed side by side on the blower pipe,
wherein the pair of heating tubes, each including a heating wire emitting infrared rays, are arranged across the open area, the blower pipe is disposed between the pair of heating tubes to be positioned more inside than the pair of heating tubes from the open area, and the blower pipe is installed so that a pressurized air flowing thereinto is blown out through the AJHs toward a point biased to one side with respect to a virtual plane that bisects the open area vertically.

2. The apparatus of claim 1, wherein each of the pair of heating tubes is configured to include a housing in which the heating wire is inserted in a longitudinal direction of the housing, and at least one side of the housing facing the open area is made of a transparent material.

3. The apparatus of claim 1, wherein the blower pipe is installed so that the pressurized air is blown out through the AJHs toward an arbitrary point within a zone on the HSTs, which are placed on the mounting table, made by vertically extending a surface of either of the pair of heating tubes exposed to the open area upto the HSTs.

4. The apparatus of claim 3, wherein the arbitrary point is at a distance of 20%˜40% of length of the HST from one end thereof.

5. The apparatus of claim 1, wherein each of the HSTs is placed on the mounting table in such a way that its one side into which an electric wire having a relatively strong heat-resistance property is inserted is located on a side toward which the pressurized air is blown through the AJHs.

6. The apparatus of claim 1, wherein the pair of heating tubes are arranged such that a distance 64 between them is in a range of 40% to 60% of length of the HST to be placed on the mounting table.

7. The apparatus of claim 1, wherein a series of guide through-holes 27 are formed on both one plane and opposite plane, respectively, of each of the HSBs, and a fastener is inserted into one of the series of guide through-holes to fix one of the heating tubes at any position on a disposed inner surface of the HSB, and
wherein fastening holes for the fastener to be inserted and coupled are formed at both ends, respectively, of each of the heating tubes.

8. The apparatus of claim 1, wherein a binding ring 28 is fixedly combined onto one side of each of the pair of HSBs, and the blower pipe inserted through the binding ring into the each HSB is rotatable, and
wherein the blower pipe is fixed not to rotate by a fixture 260 coupled to the binding ring.

9. The apparatus of claim 8, wherein a mark 22b is added, on an outer circumferential surface of the blower pipe exposed to outside without being inserted into the pair of HSBs, to indicate a direction in which the pressurized air is blown out through the AJHs, or that is 180 degrees out of phase with the direction.

10. The apparatus of claim 1, wherein the AJHs are formed on the blower pipe at same interval as an interval between the HSTs placed on the mounting table, and correspond one-to-one to the HSTs placed on the mounting table.

11. The apparatus of claim 1, further comprising a second blower pipe 26 installed in the frame under the mounting table,
wherein a plurality of pairs of air blowing holes, each pair being located at both points on a circumference that form a predetermined central angle, are repeatedly formed along a longitudinal direction of the second blower pipe, and
wherein the predetermined central angle is an angle such that the pressurized air blown out through each pair of the air blowing holes is directed to both sections, respectively, on the HST placed on the mounting table, each of the both sections being made on the HST when one plane of each of the pair of heating tubes is extended in the vertical direction upto the HST.
